(19) United States
(12) Patent Application Publication
(10) Pub. No.: US 2025/0051164 A1
(43) Pub. Date: Feb. 13, 2025

(54) PROCESS FOR PREPARING HYDRAZINE HYDRATE IN THE PRESENCE OF AN ANTI-FOAMING AGENT

(71) Applicant: ARKEMA FRANCE, COLOMBES (FR)

(72) Inventors: Jean-Marc SAGE, PIERRE-BENITE (FR); Emmanuel ACHARD, PIERRE-BENITE (FR)

(21) Appl. No.: 18/723,301

(22) PCT Filed: Dec. 20, 2022
(86) PCT No.: PCT/FR2022/052450

§ 371 Date: Jun. 21, 2024

(30) Foreign Application Priority Data
Dec. 21, 2021 (FR) FR2114191

(51) Int. Cl. C01B 21/16; B01D 3/34

(52) U.S. Cl. CPC C01B 21/16; B01D 3/34

(57) ABSTRACT

The invention relates to a process for preparing hydrazine hydrate, comprising a step of hydrolyzing an azine in a distillation column in the presence of at least one silicone of the polydialkylsiloxane, polydiarylsiloxane or polyalkyl-arylsiloxane formula.

The invention also relates to the use of at least one silicone of the polydialkylsiloxane formula as an anti-foaming agent in a process for preparing azine hydrate.

The present invention relates to a process for preparing hydrazine hydrate.

The present invention more specifically relates to a process for preparing hydrazine hydrate from alkyl ketone azine obtained in the presence of a ketone by oxidation of ammonia with hydrogen peroxide and an activator.

Hydrazine is employed in a variety of different applications, primarily in the deoxygenation of boiler waters (of nuclear power stations, for example), and is used for preparing pharmaceutical and agrochemical derivatives.

There is therefore an industrial need for the preparation of hydrazine hydrate.

Hydrazine hydrate is produced industrially by the Raschig or Bayer processes or with hydrogen peroxide.

The Raschig process sees ammonia oxidized with a hypochlorite to give a dilute solution of hydrazine hydrate, which must then be concentrated by distillation. This process, being relatively unselective, relatively unproductive and highly polluting, is virtually no longer employed.

The Bayer process is an improvement on the Raschig process, which involves shifting a chemical equilibrium by using acetone to trap the hydrazine formed in the form of azine of the following formula:

(CH₃)₂C═N—N═C—(CH₃)₂.

The azine is subsequently isolated and then hydrolyzed to hydrazine hydrate. Yields are improved, but there is no improvement in environmental emissions.

The process with hydrogen peroxide involves oxidizing a mixture of ammonia and a ketone with hydrogen peroxide in the presence of a means of activating the hydrogen peroxide to make the azine directly, which then need only be hydrolyzed to hydrazine hydrate. The yields are high and the process is less polluting. Numerous patents describe this hydrogen peroxide process, examples being U.S. Pat. Nos. 3,972,878, 3,972,876, 3,948,902 and 4,093,656.

These processes are also described in Ullmann's Encyclopedia of Industrial Chemistry (1989), vol. A 13, pages 182-183 and the references included.

In the hydrogen peroxide processes, the ammonia is oxidized by the hydrogen peroxide in the presence of a ketone and a hydrogen peroxide activation means according to the following overall reaction, forming an azine:

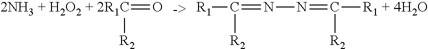

The means of activating—or activator—may be a nitrile, an amide, a carboxylic acid or else a selenium, antimony or arsenic derivative. The azine is then hydrolyzed to hydrazine, and the ketone is regenerated according to the reaction below:

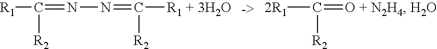

This hydrolysis is actually performed in two stages, with formation of an intermediate hydrazone:

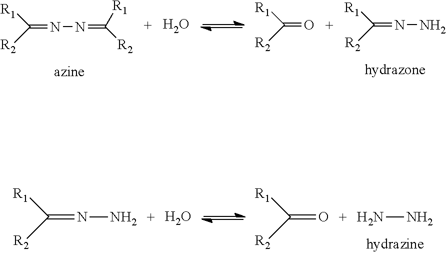

Whether the azine is produced by a hydrogen peroxide process or another process, methyl ethyl ketone is advantageously used because it is poorly soluble in an aqueous medium.

Indeed, in the process with hydrogen peroxide, the azine of methyl ethyl ketone is relatively insoluble in the reaction medium, which is necessarily aqueous as commercial aqueous solutions of hydrogen peroxide containing between 30 and 70% by weight are used. Thus this azine is easy to recover and can be isolated simply by decanting. It is highly stable particularly in an alkaline environment, viz. in the ammoniacal reaction mixture. In current processes, said azine is next purified, then hydrolyzed in a reactive distillation column to finally release methyl ethyl ketone at the head to be recycled, and above all an aqueous solution of hydrazine hydrate at the bottom. This must contain as few carbon products as possible as impurities and must be colorless.

Azine hydrolysis is known. For example, E. C. Gilbert, in an article in Journal of the American Chemical Society vol. 51, pages 3397-3409 (1929), describes equilibrium reactions of azine formation and azine hydrolysis reactions and furnishes the thermodynamic parameters of the system in the case of water-soluble azines. For example, the hydrolysis of acetone azine is described in document U.S. Pat. No. 4,724,133 (Schirmann et al.). The hydrolysis must be carried out in a reactive column, such that by continually separating the ketone at the head of the distillation column and the hydrazine hydrate at the bottom of the column, it is possible to achieve total hydrolysis. Of course, this system works best when working continuously as described in patents FR 1 315 348, GB 1 211 54 7, GB 1 164 460, U.S. Pat. No. 4,725,421 (Schirmann et al.) or even WO 00/37357.

A process for efficiently preparing hydrazine hydrate is known from document WO 2020/229773.

The synthesis process is generally carried out continuously, with the use of a distillation column for the hydrolysis step. However, it has been noted that a foam appears in the distillation column during the hydrolysis step. The foam front simultaneously causes a vapor flow and the liquid phase, thus preventing efficient separation of the products.

The presence of foam in the column thus limits the productivity thereof, and therefore the productivity of the preparation process. In fact, as soon as this foam appears, it is necessary to reduce the rate of the process in order not to lose selectivity.

In another context, document EP0761595 discloses the use of non-ionic surfactants having polyoxyethylene groups and silica as an agent against column clogging in the hydrolysis step.

And yet, it has been noted that these compounds are not effective against the appearance of foam and are not resistant to heat. Indeed, said products have a tendency to degrade. They thus foul the production circuit and generate impurities in the finished product.

In the hydrazine synthesis process, the conditions for the hydrolysis of the azine or for regeneration of the aqueous phase are very harsh, with temperatures ranging from 160 to 180° C. in the boiler, and even higher wall temperatures. It is therefore essential that the proposed anti-foaming agent does not break down under the effect of temperature.

One objective of the present invention is therefore to provide a process for preparing hydrazine hydrate, comprising a hydrolysis step, without the appearance of foam in the distillation column. The desired objective is thus to conduct a stable hydrolysis reaction over time.

The process according to the invention meets the objectives mentioned herein before.

The present inventors have surprisingly discovered that the use of a specific silicone prevented the appearance of foam in the distillation column during the hydrolysis step, thus making it possible to stabilize the production rate. Moreover, these anti-foaming agents are resistant to high temperatures. Thus, they are less sensitive to degradation, and do not foul or barely foul the distillation column and the production circuit. In fact, in the event of all or some of the reagents in the system being recycled, the claimed silicones leave fewer impurities in the production system.

The invention therefore relates to a process for preparing hydrazine hydrate, comprising a step of hydrolyzing an azine in a distillation column in the presence of at least one silicone of the polydialkylsiloxane, polydiarylsiloxane or polyalkyl-arylsiloxane formula.

The invention also relates to the use of a silicone of the polydialkylsiloxane, polydiarylsiloxane or polyalkyl-arylsiloxane formula as an anti-foaming agent in a process for preparing azine hydrate.

### DETAILED DESCRIPTION OF THE INVENTION

Other features, aspects, subjects and advantages of the present invention shall become clearer upon reading the following description.

It is specified that the expressions “from . . . to . . . ” and “of between . . . and . . . ” used in the present description should be understood as including each of the limits mentioned.

The preparation of hydrazine hydrate is carried out according to the following steps:
ammonia, hydrogen peroxide and a ketone of the formula R₁R₂C═O are reacted, in the presence of a solution comprising at least one activator in order to form an azine in a working solution; then
the azine of the ketone formed is hydrolyzed in order to obtain hydrazine hydrate.

The hydrolysis step is carried out in batches or continuously, in a reactive distillation column, into which water and the organic phase comprising the azine from the previous step are injected. Preferably, the hydrolysis step is carried out continuously.

The hydrolysis can be carried out in a packed or plate distillation column.

Preferably, the distillation is carried out under pressure, and more particularly under a pressure of 2 to 25 bar.

Advantageously, the distillation is carried out with a bottom temperature of between 150° C. and 200° C., preferably between 175° C. and 190° C.

According to a preferred embodiment, the hydrolysis can be carried out in a packed or plate distillation column, preferably operating under a pressure of 2 to 25 bar and with a bottom temperature of between 150° C. and 200° C.

While conventional packed columns may be suitable, plate columns are generally employed. Depending on the residence time permitted on the plates and the pressure in the column, and therefore the operating temperatures, the number of plates may vary. Generally, when operating under a pressure of 8 to 10 bar and between 175° C. and 190° C., the number of plates required is in the range of 40 to 70.

The molar ratio of water to azine to feed this column is at least greater than the stoichiometry, and advantageously between 5 and 30, preferably between 10 and 20.

The azine, which undergoes the hydrolysis step, is the reaction product of the oxidation of ammonia in the presence of a ketone of formula R₁R₂CO. The R₁ and R₂ groups denote, independently of each other, a linear or branched C₁-C₁₀alkyl. In particular, the R₁ and R₂ groups denote, independently of each other, a methyl, ethyl, propyl, butyl, pentyl, hexyl, heptyl and octyl group. Preferably, dimethyl ketone and methyl ethyl ketone are used. In a particularly preferred manner, methyl ethyl ketone is used. The preferred azine is therefore the azine of methyl ethyl ketone, called MEKazine.

For the purpose of the present invention, a silicone comprises identical or different units, of formula —(Si(—R₃)(—R₄)—O—), the R₃ and R₄ groups denoting, independently of each other, an alkyl group or an aryl group.

In the process according to the invention, at least one polydialkylsiloxane, polydiarylsiloxane or polyalkyl-arylsiloxane silicone is added to the reaction medium. This silicone will prevent the formation of foam in the column.

Preferably, the silicone according to the invention is non-volatile; in other words, it has a viscosity greater than 5 cSt at 25° C., notably a silicone oil with a vapor pressure less than 13.3 Pa at 25° C.

For the purposes of the present invention, polydialkylsiloxane is understood to mean siloxanes which comprise linear, branched or cyclic C₁-C₁₈ alkyl groups, preferably methyl, ethyl, propyl, butyl, pentyl, hexyl, cyclohexyl, heptyl, octyl, and may optionally carry fluorine atoms, as a substituent.

For the purposes of the present invention, polydiarylsiloxane is understood to mean siloxanes which comprise C₆-C₁₀ aryl groups, preferably phenyl, and may optionally carry fluorine atoms.

For the purposes of the present invention, polyalkyl-arylsiloxane is understood to mean siloxanes which comprise C₁-C₁₈ alkyl groups and C₆-C₁₀ aryl groups, preferably methyl and phenyl, and may optionally carry fluorine atoms.

The silicone according to the invention, preferably non-volatile and having a viscosity greater than 5 cSt at 25° C., can be selected from the polydimethylsiloxanes, polydiphenylsiloxanes, polymethylphenylsiloxanes and polyethylphenylsiloxanes. Advantageously, the silicone according to the invention is an aliphatic polydialkylsiloxane, preferably a polydimethylsiloxane called PDMS hereinafter.

According to a specific embodiment, the viscosity of the silicone used in the process according to the invention is between 5 and 1,000,000 cSt at 25° C., preferably between 50 cSt and 100,000 cSt, and even more preferentially between 80 and 10,000 cSt.

The international system unit for kinematic viscosity is m²/s. Some silicone manufacturers express viscosity in centistokes or cSt. The following should be noted: 1 cSt=0.01 St=1 mm²/s.

Other manufacturers also indicate the dynamic viscosity expressed as centipoise or cP or cPs or cs. The following should be noted: 1 cP=0.001 Pa·s.

Advantageously, the silicone can be in the form of an emulsion, preferably aqueous.

The silicone is preferably present in the aqueous emulsion in a content of between 1 and 45% by weight relative to the total weight of the emulsion, preferably between 4 and 30% by weight.

Preferably, the silicone can be mixed with silica. Preferably, the silica is present in a content of between 1 and 45% by weight relative to the total weight of the mixture of silicone and silica, preferably between 4 and 30% by weight.

By way of example, mention may be made of the following polydimethylsiloxanes:
the AK range proposed by Wacker, ranging from 5 to 60,000 cSt at 25° C., such as AK 100, AK 1000, AK 12500;
the Xiameter PMX range proposed by Dow, such as Xiameter PMX 200 Silicone Fluid 100 cPs, Xiameter PMX 200 Silicone Fluid 350 cPs, Xiameter PMX 200 Silicone Fluid 1000 cPs;
the Bluesil range proposed by Elkem, such as Bluesil 47 V 100, Bluesil 47 V 500 or Bluesil 47 V 1000, the last numbers of the name giving information about the dynamic viscosity in mPas of the oil.

Elkem proposes polydimethylsiloxanes formulated in aqueous emulsions, such as for example Silcolapse RG 12.

Elkem also proposes suspensions of silica in polydimethylsiloxanes, such as for example Silcolapse 411.

From the silicones according to the invention with aryl groups, the polydiarylsiloxanes, notably polydiphenylsiloxanes, and polyalkyl-arylsiloxanes may be used. By way of example, mention may be made of the following commercial products:
the methylphenylpolysiloxanes sold by Shin Etsu, under the name KF 96-100, KF 96-1000, the range offers silicones with a viscosity ranging from 5 to 10,000 mm²/s (centistokes) in terms of kinematic viscosity,
the methylphenylsiloxanes sold by Wacker, under the AS range, notably AS 100PDMS,
the methylphenylpolysiloxanes sold by Shin Etsu, under the name KF 50-100, KF 50-1000 and KF-54.

From the fluorinated silicones, silicones comprising
—(Si(—CH₃)(—CH₂—CH₂—CF₃)—O—) units are preferred.

The commercial products FF160 and FF170 sold by Momentive are suitable.

The FS-1265 Fluid products, of 300 or else 1000 or even 10000 cSt, sold by Dow may also be used.

According to one embodiment of the invention, it is possible to use a mixture of silicones.

When the process is performed in batches, the silicone(s) can be added to the reaction medium prior to the hydrolysis step. The silicone can be in dissolved form or even dispersed in the medium. It is also possible to add it directly into the column.

Typically, in a continuous process, the water is preferably introduced into the top part (head) of the column, whereas the azine organic phase is preferably introduced between the middle and the top of the column.

The anti-foaming agent is preferably added to the system at the head of the column, with the aqueous phase.

Preferably, the silicone is introduced in a content ranging from 1 ppm to 5000 ppm by weight relative to the azine of the dialkyl ketone, preferably between 5 ppm and 4000 ppm by weight relative to the azine of the dialkyl ketone.

When the silicone is in pure form, the silicone is introduced in a content ranging from 10 ppm to 4000 ppm by weight relative to the azine of the dialkyl ketone, preferably between 20 ppm and 1000 ppm by weight relative to the azine of the dialkyl ketone, more particularly between 40 ppm and 500 ppm by weight relative to the azine of the dialkyl ketone.

When the silicone is in aqueous emulsion form, the emulsion is introduced in a content ranging from 1 ppm to 500 ppm by weight relative to the azine of the dialkyl ketone, preferably between 1 ppm and 200 ppm relative to the azine of the dialkyl ketone.

Following hydrolysis, the ketone is obtained at the head, notably in the form of an azeotrope with water, and at the bottom, an aqueous solution of hydrazine hydrate is obtained.

Solutions at 30% or even up to 45% by weight of hydrazine hydrate can be obtained at the bottom of the column.

Furthermore, the anti-foaming agent can also be used in another column of the azine synthesis process.

Following the reaction step, the azine is separated from the aqueous phase, said aqueous phase being the working solution containing water and the activator, obtained after the formation of the azine. The separation is carried out for example by decantation. Then, the working solution is regenerated. The process for regenerating and recycling the working solution is known from document EP399866, the content of which is incorporated by reference in the present description. The working solution is brought to at least 130° C. whilst removing the reaction water and the water supplied by the hydrogen peroxide dilution water in the form of a stream containing water, ammonia, ketone and C₀₂. The stream obtained in the previous step is introduced into a stripping column, in the presence of at least one silicone as defined herein before, as an anti-foaming agent. The ammonia stripping column is known from document EP0518728, the content of which is incorporated by reference in the present description. The use of silicone at this stage of the process also makes it possible to stabilize, in a sustainable manner, the distillation of the column, without generating impurities in the circuit.

The invention also relates to the use of at least one silicone of the polydialkylsiloxane, polydiarylsiloxane or polyalkyl-arylsiloxane formula as defined herein before, as an anti-foaming agent in a process for preparing azine hydrate.

According to one embodiment, the silicone is introduced into the distillation column allowing the hydrolysis of an azine.

According to another embodiment, the silicone is introduced into the ammonia stripping column fed by a flow from the step of regenerating the working solution recovered after the ammonia, hydrogen peroxide and ketone reaction step to form the azine.

The examples which follow make it possible to illustrate the present invention but are not in any way limiting.

### EXAMPLES

### Series of Industrial Tests

### Comparative Example 1

A process as disclosed in example 1 of document WO 2020/229773 was implemented for the synthesis of hydrazine hydrate, from MEKazine. The hydrolysis column as disclosed in this document was used, without the addition of additives for a flow rate of 6000 kg/h of hydrazine introduced and 12,000 kg of water.

After 5 days, clogging of the column and instability of the distillation were observed, which then made it necessary to reduce the production rate in order to re-establish the correct temperature profile on the plates.

The bottom of the column was at 180° C. and the pressure in the column was 9 bar absolute.

### Comparative Example 2

A process as disclosed in example 1 of document WO 2020/229773 was implemented for the synthesis of hydrazine hydrate, from MEKazine. The hydrolysis column as described in this document was used, with the addition of an ethoxylated derivative of palmitic acid.

After about fifteen days of operation, the formation of a deposit on the walls of the boiler, as well as in other parts of the hydrazine hydrate concentration train, was observed.

After analysis, this deposit was characterized as palmitic hydrazide.

### Example 3 According to the Invention

A process as disclosed in example 1 of document WO 2020/229773 was implemented for the synthesis of hydrazine hydrate, from MEKazine. The hydrolysis column as described in this document was used, with the addition of a PDMS 100 cPs silicone under the trade name Xiameter PMX 200 Silicone Fluid 100 cSt at a flow rate of 1 to 2 kg/h for 6000 kg/h of hydrazine introduced and 12,000 kg of water. The column remained in stable operation at this regime for a period of more than 2 months.

The results of these 3 examples appear in summary table 1 below.

| | | Operating time of the |
|---|---|---|
| | Additive | hydrolysis column |
| Comparative | — | 5 days |
| example 1 | | |
| Comparative | Ethoxylated derivative | 15 days |
| example 2 | of palmitic acid | |
| Invention | PDMS 100 cPs | More than 2 months |
| example 3 | | |

These results show that the silicones according to the invention make it possible to stabilize the distillation in a sustainable manner, without contaminating the circuit of the process with deterioration products.

### Series of Laboratory Tests

The anti-foaming effect of the additives was tested in the laboratory.

10 g of the methyl ethyl ketone azine taken from the distillative azine purification step of the process was placed in 90 mL of water at reflux at 95° C., under a nitrogen flow rate of 300 mL/min. The reaction medium generated a foam. It was necessary to wait a few minutes to allow time for the height of the foam to stabilize. This stabilized at a height of 4-5 cm above the level of liquid in the reactor.

An anti-foaming agent was added to the reaction medium by means of a peristaltic pump, at a flow rate of 0.1 g/min (previously calibrated with each anti-foaming compound evaluated) via a thin tube which allowed the anti-foaming agent to be introduced at approximately 1 drop every 10-15 seconds at this flow rate.

The variation in the reduction in the foam height (H) was recorded during the introduction of the anti-foaming agent (Hinitial−H(t))/Hinitial.

The results of these examples are given in summary table 2 below. Examples 4 to 8 are according to the invention and examples 9 and 10 are comparative.

| | | Time in minutes | | | | |
|---|---|---|---|---|---|---|
| | | 1 | 2 | 3 | 4 | 5 |
| | | Amount of anti-foaming agent in grams | | | | |
| | | 0.1 | 0.2 | 0.3 | 0.4 | 0.5 |
| | | ΔH = (Hinitial − H(t))/Hinitial | | | | |
| Ex4 | PDMS 100 cPs silicone¹ | 5% | 10% | 20% | 60% | 70% |
| Ex 5 | PDMS 500 cPs silicone | 5% | 10% | 20% | 60% | 70% |
| | with 10% silica² | | | | | |
| Ex6 | PDMS 1000 cPs | 10% | 20% | 40% | 50% | 60% |
| | silicone³ | | | | | |
| Ex7 | PDMS 10,000 cPs | 80% | 90% | 95% | 95% | 95% |
| | silicone⁴ | | | | | |
| Ex8 | Silicone/silica emulsion⁵ | 80% | 90% | 95% | 95% | 95% |
| Ex9 | Polyether⁶ | −20% | 33% | 53% | 66% | 53% |
| Ex10 | Polyether⁷ | −55% | 44% | 55% | 44% | 55% |

¹ The anti-foaming agent used is a PDMS 100 cPs silicone. It is sold by Dow under the trade name Xiameter PMX 200 Silicone Fluid 100 cPs.

² The anti-foaming agent used is a PDMS 500 cPs silicone comprising 10% by weight of silica. It is sold by Elkem under the trade name Silcolapse 411.

³ The anti-foaming agent used is a PDMS 1000 cPs silicone. It is sold by Sigma-Aldrich under the trade name “Silicon oil” with a viscosity of 1000 cPs.

⁴ The anti-foaming agent used is a PDMS 10000 cPs silicone. It is sold by Sigma-Aldrich under the trade name “Silicon oil” with a viscosity of 10000 cPs.

⁵ The anti-foaming agent used is an aqueous emulsion having 10% by weight of a silicone and 10% by weight of silica. It is sold by Elkem under the trade name Silcolapse RG12.

⁶ The anti-foaming agent used is an EO/PO polyether having a mass of 2000 g/mol with 10% EO units and a viscosity of 350 cPs. It is sold by BASF under the trade name Pluronic PE 6100.

⁷ The anti-foaming agent used is an EO/PO polyether having a mass of 3500 g/mol with 10% EO units and a viscosity of 800 cPs. It is sold by BASF under the trade name Pluronic PE 10100.

Regarding examples 9 and 10, when the anti-foaming agent is added, as soon as the first drops are added to the medium, a foaming character is observed with an increase in the foam height of up to 55% in the case of example 9.

Moreover, it is observed in comparative examples 8 and 9 that the foam level is not stabilized. It decreases then increases.

Regarding the examples according to the invention, a sharp decrease in foam is observed.

Consequently, the silicones according to the invention prevent the formation of foam as soon as they are introduced into the distillation column. The effect can be qualified as immediate.

1. A process for preparing hydrazine hydrate, comprising a step of hydrolyzing an azine in a distillation column in the presence of at least one silicone of the polydialkylsiloxane, polydiarylsiloxane or polyalkyl-arylsiloxane formula.

2. The process according to claim 1, characterized in that the silicone is selected from the polydimethylsiloxanes, polydiphenylsiloxanes, polymethylphenylsiloxanes and polyethylphenylsiloxanes

3. The process according to claim 1 or 2, characterized in that the silicone has a viscosity of between 5 and 1,000,000 cSt, preferably between 50 and 100,000 cSt, and more particularly between 80 and 10,000 cSt at 25° C.

4. The process according to any one of the preceding claims, characterized in that the silicone is a polydimethylsiloxane.

5. The process according to any one of the preceding claims, characterized in that the silicone is in the form of an aqueous emulsion.

6. The process according to any one of the preceding claims, characterized in that the silicone is introduced at the head of the distillation column, with the water introduced into the column for hydrolysis.

7. The process according to any one of the preceding claims, characterized in that the silicone is introduced in a content ranging from 1 ppm to 5000 ppm by weight relative to the azine, preferably between 5 ppm and 4000 ppm by weight relative to the azine.

8. The process according to any one of the preceding claims, characterized in that the azine is methyl ethyl ketone azine or dimethyl ketone azine, preferably the azine is methyl ethyl ketone azine.

9. The process according to any one of the preceding claims, characterized in that the process comprises:
a step of reacting ammonia, hydrogen peroxide and ketone in the presence of a solution comprising at least one activator to form an azine in a working solution, prior to the hydrolysis step defined in the preceding claims.

10. The process according to claim 9, characterized in that it comprises the following steps:
separating the azine from the working solution;
regenerating the working solution by bringing it to at least 130° C. whilst removing the reaction water and the water supplied by the hydrogen peroxide dilution water in the form of a stream containing water, ammonia, ketone and CO₂;
passing the stream obtained in the preceding step through a stripping column, in the presence of at least one silicone as defined in any one of claims 1 to 5, as an anti-foaming agent.

11. The use of at least one silicone as defined in any one of claims 1 to 5 as an anti-foaming agent in an azine hydrate preparation process.

12. The use according to claim 11, characterized in that the silicone is introduced into the distillation column allowing the hydrolysis of an azine.

13. The use according to claim 11 or 12, characterized in that the silicone is introduced into an ammonia stripping column fed by a flow from the step of regenerating the working solution recovered after the ammonia, hydrogen peroxide and ketone reaction step to form the azine.
